(19) United States
(12) Patent Application Publication
(10) Pub. No.: US 2008/0225420 A1
(43) Pub. Date: Sep. 18, 2008

(54) Multiple Aperture Optical System

(76) Inventors: Geoffrey L. Barrows, Washington, DC (US); Craig W. Neely, Vienna, VA (US)

Correspondence Address: Geoffrey L. Barrows;Centeye, Inc., 1010 Vermont Avenue NW, Suite 200, Washington, DC, 20005, US

(21) Appl. No.: 11/685,203

(22) Filed: Mar. 13, 2007

(51) Int. Cl. G02B 23/00

(52) U.S. Cl. 359/850

(57) ABSTRACT

A multiple aperture optical system is provided that overcomes many limitations of wide field of view imaging systems. A basic component of the multiple aperture optical system is an “eye strip”, which comprises an array of imaging apertures physically mounted onto a flexible circuit strip and a master processor. Each imaging aperture generates an aperture output based on the imaging aperture's field of view. The master processor takes as input the aperture outputs generated by the apertures on the eye strips, and generates an output in response. In one embodiment, the multiple aperture optical system enables obtaining an omnidirectional image in a structure that is thin and can be physically conformed to an underlying structure.

### FEDERALLY SPONSORED RESEARCH

This invention was made with Government support under Contract No. FA865105C0211 awarded by the United States Air Force. The Government has certain rights in this invention.

### CROSS-REFERENCE TO RELATED APPLICATIONS

Not Applicable.

### TECHNICAL FIELD

The teachings presented herein relate to machine vision. Particularly the teachings relate to imaging and image processing and the systems incorporating the teachings therein.

### BACKGROUND

An important technical challenge is that of providing on-board vision to small aerial platforms, ranging from micro air vehicles (MAVs) to guided munitions. The benefits include the ability to autonomously maneuver through a cluttered environment while avoiding collisions, take off and land, identify and pursue targets of interest, and know the general position without reliance upon GPS. These abilities are useful in current military operations, which increasingly take place in complex urban environments. Challenges facing the design of such vision systems include the following:

Field-of-View: One challenge is in providing an imaging system with a wide field of view. Without using heavy “fish-eye” optics, the widest practical field of view of a single camera is on the order of 90 degrees. This may not be adequate for many applications involving MAVs, in particular for autonomous flight through a cluttered environment. Such autonomous systems would benefit from a vision system having a near omni-directional field of view.

Volume: Most cameras comprise a single imager and a lens to focus light onto the imager. A camera is effectively a box, with an imager at one end on the inside, and a lens on the other end. The lens needs to be precisely placed, requiring adequate support structures on the sides. Furthermore the space between the lens and the imager is generally empty and is thus wasted space. The result is that the camera may be too large to be integrated within a MAV's airframe.

Mass: The lenses themselves plus the structures that hold them rigidly in place contribute to the weight of the imaging system as a whole, especially if a fisheye lens is used. The mass of the optics is often greater than the mass of the imaging chip itself. Qualitatively, the optics assembly needs to be heavier for imaging systems having a higher resolution or an ultra-wide field of view, since both the lens and its enclosure must be even more rigidly fabricated to meet tighter tolerances.

Physical conformity: The box-like shape of most camera systems may not fit into many air vehicle platforms, which generally have a narrow and/or streamlined shape. Instead, the shape of the air vehicle essentially needs to conform to the shape of the camera system and still provide an adequately streamlined enclosure. Very often, the camera system and its physical support structures exceeds the size of the fuselage, resulting in a bulge that can have an adverse affect on the vehicle's aerodynamics.

Speed: The market forces driving the development of camera systems are dominated by digital still cameras, cell-phone cameras, and video cameras. Such systems are designed for capturing and storing images in a manner that allows them to be reproduced at a later time for viewing by humans, with minimal effort focused on increasing frame rate. Both the frame capture rates and the data formats generated by such imagers are not ideal for measuring qualities such as optical flow or for detecting obstacles when flying through urban environments. Furthermore most imagers capture no more than 60 frames per second, which introduces undesirable lags into aircraft control loops and is not sufficiently fast when flying at high speeds and close to threatening objects. The net implication is that very powerful CPUs are needed to perform the computations, which are too power-hungry or heavy for insertion on MAVs.

Physical robustness: In a single aperture camera system, if the camera is physically impacted during an operation, the system may be blinded. It is possible to make an imaging system physically robust, but this generally requires increasing the amount of material in the support structure, which increases the mass.

One method of providing MAVs with the ability to sense the environment is with the use of optical flow. Optical flow is the apparent visual motion seen from an imager or eye that results from relative motion between the imager and other objects or hazards in the environment. Refer to the book The Ecological Approach to Visual Perception by John Gibson for an introduction to optical flow. Consider a MAV flying forward above the ground. The optical flow in the downward direction is faster when the ground is closer, thus optical flow can provide information on the terrain shape below. Optical flow in the forward direction indicates the presence of obstacles from which the MAV must turn. Finally, the same optical flow sensing can provide information on rotation and translation, allowing it to detect and respond to turbulence.

Further examples on how optical flow can be used for obstacle avoidance are discussed in the paper “Biologically inspired visual sensing and flight control” by Barrows, Chahl, and Srinivasan and the Ph.D. dissertation “Mixed-Mode VLSI Optical Flow Sensors for Micro Air Vehicles” by Barrows. The application of optical flow to robotics and other fields is a mature art. Many other publications are available in the open literature on how to use optical flow for various applications.

The above challenges are also present for ground robotic platforms and/or underwater robotic platforms. For purposes of discussion, the term “mobile robotic system” as used herein refers to any system that is capable of generating movement, including but not limited to airborne, ground, or water-borne systems, or any system that is capable of affecting it's trajectory, for example airborne gliders. The subject matter and teachings below are applicable to all types of vehicles, robotic systems, or other systems that contain optical flow sensors or use optical flow sensing.

As set forth in earlier U.S. patents and other publications, techniques exist to fabricate optical flow sensors that are small, compact, and sufficiently light to be used on MAVs. Particularly relevant U.S. patents include U.S. Pat. Nos. 6,020,953 and 6,384,905. Particularly relevant books include Vision Chips by Moini and Analog VLSI and Neural Systems by Mead. Other particularly relevant publications include “Mixed-mode VLSI optical flow sensors for in-flight control of a micro air vehicle” by Barrows and Neely and the above-referenced Ph.D. dissertation by Barrows. Another variation of vision chips are “cellular neural network (CNN)” arrays having embedded photoreceptor circuits, as described in the book Towards the Visual Microprocessor edited by Roska and Rodrígues-Vázques. Other relevant prior art is listed in the references section below.

Consider now the prior art in optical flow sensors. Refer to FIG. 1, which shows a generic optical flow sensor 101 for computing optical flow. The sensor 101 is divided into a four-part architecture, which may be considered a generalization of the sensors described in the above-referenced prior art. A lens 103 focuses light from the visual field 105 to form an image on a vision chip 107. The lens 103 may be a standard simple or compound lens, or may be any other optical structure configured to form an image on the vision chip 107. The lens 103 is mounted a predetermined distance, called the “focal length”, from the vision chip 107. The vision chip 107 is divided into an array of pixels, each pixel representing a small portion of the image. The pixels may also be referred to as photoreceptors, with the resulting values associated with respective pixels referred to as a photoreceptor signals. Therefore an initial step performed by the vision chip 107 is to convert the image created by lens 103 into an array of photoreceptor signals 109, which is performed by the photoreceptor array 111 on the vision chip 107.

The output of the photoreceptor array 111 may form an array of pixel values or “snapshot” of the visual field 105 much like that generated by the imager of a digital camera or camcorder. Therefore the set of photoreceptor signals 109 generated by an imager or a vision chip 107 may equivalently be referred to as an image or as an array of pixel values, and vice versa. Furthermore the act of grabbing an image may be referred to as the act of generating photoreceptor signals or an image from the visual field, whether performed with a lens or other optical structure. The visual field of an imager or a camera is defined as the environment which is visible from the imager or camera. Note that in the discussion below, the words “imager” and “vision chip” may be used interchangeably, with “imager” referring to any device that grabs an image, and “vision chip” referring to a device that both grabs an image and performs some processing on the image. Thus a vision chip may be considered to be an imager.

In the context of U.S. Pat. Nos. 6,020,953 and 6,384,905 these photoreceptors may be implemented in linear arrays, as further taught in U.S. Pat. No. 6,194,695. Photoreceptors may also be implemented in regular two-dimensional grids or in other array structures as taught in U.S. Pat. Nos. 6,194,695, 6,493,068, and 6,683,678. Circuits for implementing such photoreceptors are described in these patents.

The second part of the sensor 101 is an array of feature detectors 115. This feature detector array 115 generates an array of feature signals 117 from the photoreceptor signals 109. The feature detector array 115 detects the presence or absence of feature such as edges in the visual field (or in the image on the vision chip or imager). On most prior art image processing systems, feature detectors are implemented with software algorithms that process pixel information generated by an imager or vision chip. On the optical flow sensors described in U.S. Pat. Nos. 6,020,953 and 6,384,905, feature detector arrays are implemented with circuits such as winner-take-all (WTA) circuits within the vision chip. In these patents, the resulting winner-take-all signals may be referred to as binary feature signals. The resulting binary feature signals 117 may be analog or digital, depending on the specific implementation. For purposes of discussion, feature detector signals may be described as comprising a single digital bit, with each signal corresponding to a specific location of the visual field. The bit may be digital “1” to indicate the presence of a feature at that location of the visual field (or image on the vision chip or imager), and may be digital “0” to indicate the absence of a feature at that location. Note that alternative embodiments that generate either multi-bit information or analog signals may still be considered within the scope of the current teaching.

The third part of the sensor 101 is an array of motion detectors 123, where the motion of features across the visual field 105 is detected and the speed measured. These motion detectors may be implemented as algorithms that exist on a processor 121, although some of the prior art (also discussed in U.S. Pat. No. 6,020,953) teaches variations in which motion detectors may be implemented as circuits on the same vision chip 107 as the photoreceptors 111 and feature detectors 115. The motion detectors 123 generate “velocity reports” 125, with each velocity report corresponding to a single instance of a measured optical flow value.

Algorithms for motion detection include “transition detection and speed measurement”, as taught in U.S. Pat. Nos. 6,020,953 and 6,384,905. Other methods of motion detection are discussed in the above-referenced Ph.D. dissertation by Barrows. In these algorithms, sequential frames of binary feature signals are grabbed from a vision chip, and motion detection algorithms are implemented every frame using a state machine. At any single frame, zero, one, or more velocity reports may be generated. Over the course of multiple frames, velocity reports are generated as visual motion is detected by the state machines. Therefore it is said that the motion detectors generate multiple velocity reports, even though these velocity reports do not necessarily occur at the same time. Velocity reports are also discussed below with FIG. 3.

The fourth part of the sensor 101 is the fusion section 131, where the velocity reports 125 are processed and combined to produce a more robust and usable optical flow measurement 135. This measurement 135 may be a single optical flow measurement corresponding to the field of view of sensor 101, or may be an array of measurements corresponding to different subsections of the field of view. Fusion is also generally, but not necessarily, performed on the processor 121. Fusion is the primary subject of U.S. Pat. No. 6,384,905. In U.S. Pat. No. 6,384,905, fusion is the process implemented in Steps 192 through 199 as described in column 14 of the patent's specification, or on Steps 175 through 177 as described in column 15 of the patent's specification.

Refer to FIG. 2, which depicts a 6-by-6 array of binary feature signals 201 as might be generated by the feature detectors 115 of FIG. 1. For discussion, only a 6-by-6 array is shown, although the array may be much larger. In this case, consider the array 201 as a subset of the entire array of binary feature signals 117 generated by the feature detector array 115. Each binary feature signal is represented either as an empty circle for an “off” pixel (for example “off” pixel 203) or as a filled circle for an “on” pixel (for example “on” pixel 205). “On” and “off” values correspond respectively to the presence or lack of a feature at the corresponding location the visual field. For example, the feature may be an “edge” and the pixel's binary value would then indicate the presence or absence of an edge at that location of the visual field. The array 201 of binary feature signals may be considered to be a “binary image”.

One method for measuring optical flow is to track the motion of high feature detector signals across the visual field. Refer to FIG. 3, which shows another binary feature array 301 of essentially the same type as FIG. 2, but depicts a single “on” signal moving through a trajectory 303 that is two pixels wide. Due to motion in the visual field, this “on” pixel starts at a start location 305, travels along trajectory 303 through location 306, and finishes at end location 307. If this distance of two pixels is divided by the time used to move this distance, the result is a “velocity report”. For example, if the time used to move two pixels was 100 milliseconds then the velocity report in this case would be 2/0.1=20 pixels per second.

In an actual implementation, there are many such trajectories that can cause a velocity report. For example, it is possible to define another trajectory as starting at location 307, passing through location 308, and ending at location 309. A reverse trajectory, indicating motion to the left, may be defined that starts at location 307, passes through location 306, and ends at location 305. Such a reverse trajectory would indicate motion in the opposite direction, and may accordingly be given a negative sign. Yet another trajectory may be defined as starting from location 311, passing through location 312, and ending at location 313. To obtain maximum sensitivity to motion, all such trajectories possible over the array 301 may be measured, so that motion anywhere may generate a velocity report. Shorter trajectories just one pixel long may be defined, for example from location 313 to location 321. Likewise longer trajectories may be defined, such as the three pixel long trajectory start at location 311 and ending at location 321. Vertical trajectories may be defined, for example involving locations 321, 322, and 323. Any time an edge moves through a trajectory that the motion detector is configured to detect, a velocity report may be generated, with the velocity report being a distance-divided-by-time measurement.

In the context of U.S. Pat. No. 6,020,953, velocity reports are the outputs of the “Transition Detection and Speed Measurement” circuit of FIG. 2 of this patent, which result from “valid transitions”, as defined in this patent. Steps 357, 359, and 365 of FIG. 16 also generate a velocity report, which is provided as an output by the variables “speed” and “direction” in Step 361. The trajectories defined in this patent cover one pixel of distance. Many such transition detection and speed measurement circuits may be implemented over the entire array to obtain maximum sensitivity to motion.

In the context of the above referenced U.S. Pat. No. 6,384,905, velocity reports are the variables m(j) computed by the function TIME_TO_VEL( ) on program line 174, shown in column 15 of U.S. Pat. No. 6,384,905. This value is referred to as a “velocity measurement” in this patent. The trajectories defined in this patent also cover one pixel of distance. To achieve greater sensitivity to motion, the algorithm implemented in this patent may be replicated across the visual field.

Trajectories over one or more pixels in length may be monitored using one of many different techniques that exist in the open literature to track the motion of a high digital signal over time. Possibilities include using state machines to detect motion across a trajectory and timers or time stamps to record how much time was necessary to move through the trajectory. A possible state machine may be configured to detect motion along the (location 305) (location 306)→(location 307) trajectory, or the motion in the opposite direction, in order to detect motion. The state machine may output a command to grab a starting time stamp when, for example, location 305 is high, and may then output a command to grab an ending time stamp and generate a velocity report when, for example, the high signal has moved through the trajectory 303 to location 307. The state machine may also output a sign bit to indicate the direction of motion detected. Some additional mechanisms for detecting such longer features are discussed in the above-referenced Ph.D. dissertation by Barrows.

Any generated velocity report may be converted to a measurement in “radians per second” from the angular pitch between neighboring pixels when projected out into the visual field. If vₚ is the velocity report in “pixels per second”, f the focal length of the lens 103, and p the pitch between pixels, then the velocity report vᵣ in “radians per second” is (to a first-order approximation) vᵣ=(p/f)vₚ. This value can be converted to a “degrees per second” by multiplying vᵣ by 180/π.

Note that although the above discussion of FIGS. 2 and 3 use binary feature arrays arranged on a square grid, other type of arrays are possible. For example, in the context of U.S. Pat. Nos. 6,020,953 and 6,384,905, photoreceptor arrays and binary feature detector arrays are arranged in predominantly a linear pattern for computing one-directional optical flow. In these cases, the binary feature detector arrays 201 and 301 would be predominantly one-dimensional, and the trajectories would be strictly along the array.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows a prior art optical flow sensor.

FIG. 2 shows a 6-by-6 array of binary feature signals.

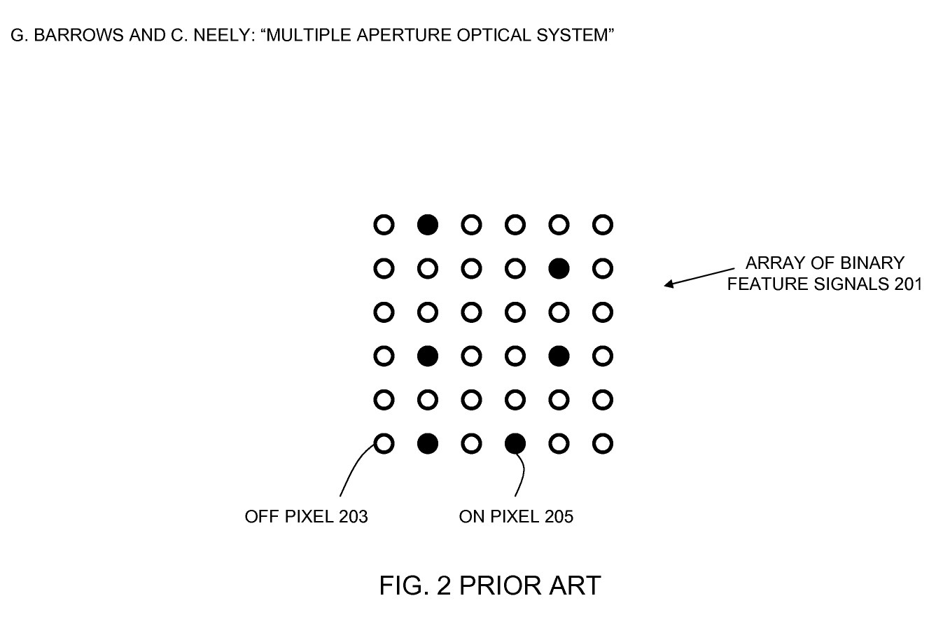

FIG. 3 shows a trajectory traced by a high binary feature signal.

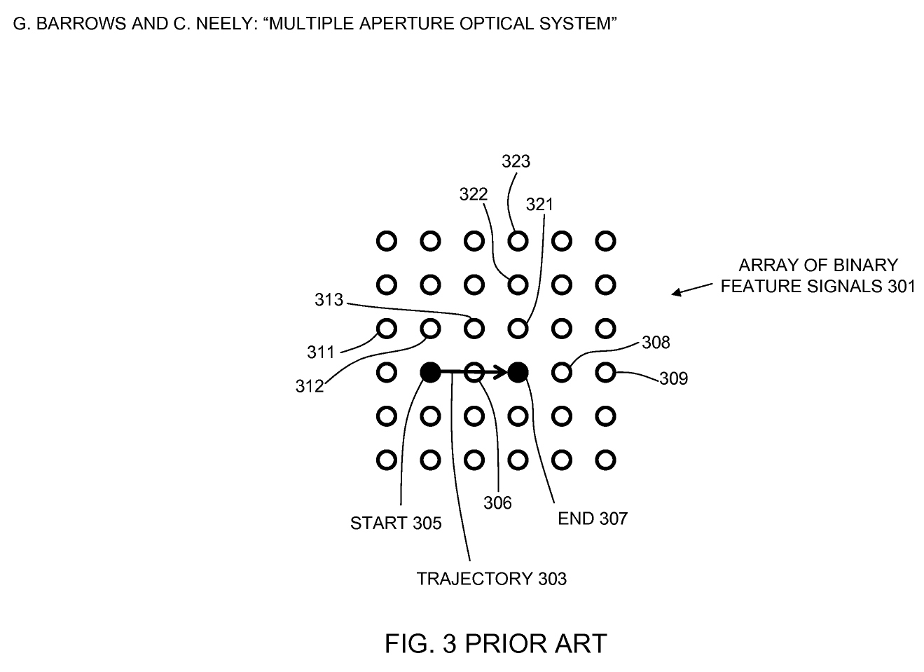

FIG. 4 shows the architecture of an exemplary embodiment.

FIG. 5 shows the architecture of one aperture.

FIG. 6 shows one possible aperture cross section.

FIG. 7 shows another possible aperture cross section.

FIG. 8 shows the cross section of an alternative aperture.

FIG. 9 shows an exploded view of the aperture of FIG. 8

FIGS. 10A and 10B show the structure of an eye strip.

FIG. 11 shows another view of the eye strip of FIGS. 10A and 10B in which the eye strip is bent.

FIG. 12 shows an eye strip wrapped around a support structure.

FIG. 13 shows the construction of an omnidirectional vision system from multiple eye strips.

FIG. 14 shows a serpentine pattern for providing an eye strip with additional flexibility in the sideways direction.

FIG. 15 shows a multiple imager aperture.

FIG. 16 shows a curved multiple imager aperture.

### DESCRIPTION OF EXEMPLARY EMBODIMENTS

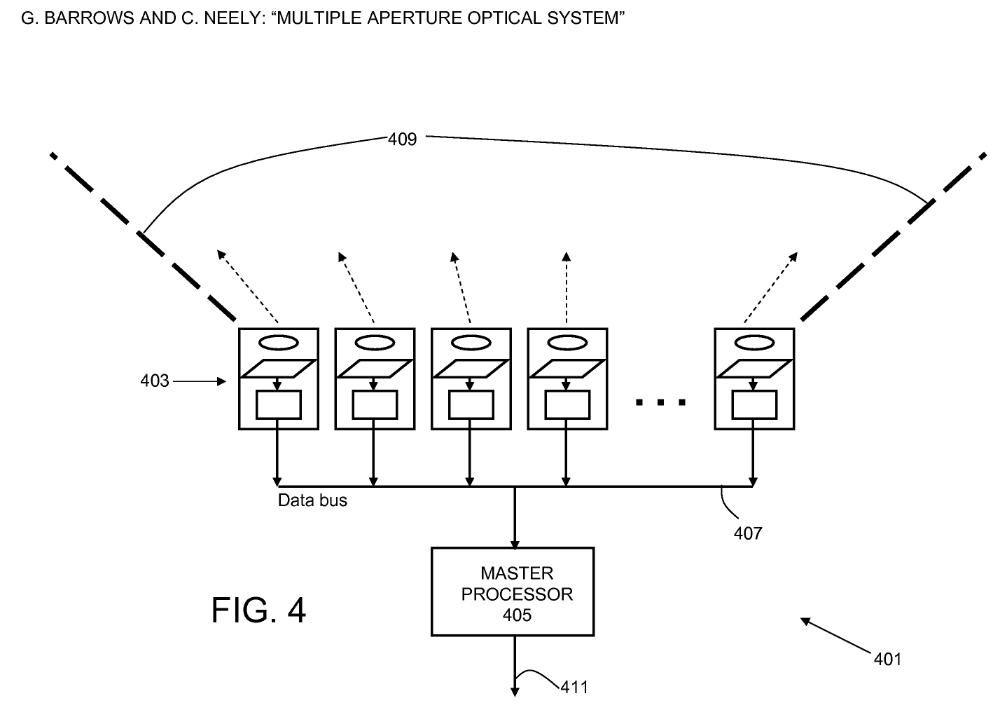

Refer to FIG. 4, which shows a circuit architecture 401 of an exemplary embodiment. A multiple aperture optical system comprises an array of apertures 403, a master processor 405, a data bus 407 connecting the array of apertures 403 with the master processor 405, and a master processor program (not shown) running on the master processor 405. The apertures 403 are arranged so that their individual fields of view together cover a larger field of view, which is referred to herein as the multiple aperture optical system's field of view 409. The master processor 405 generates a master processor output 411 based on the results of the master processor program.

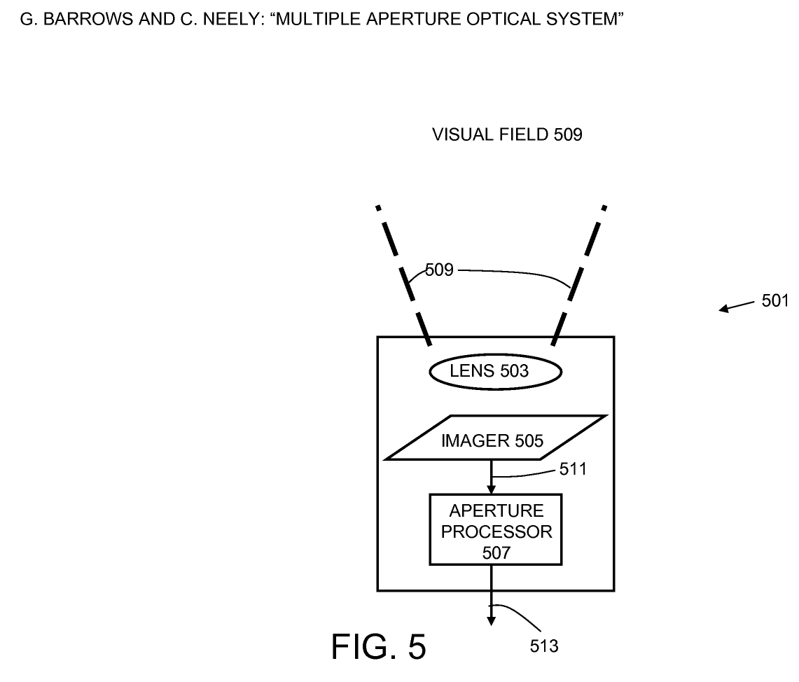

Refer to FIG. 5, which shows one possible structure of one single aperture 501 of the aperture array 403 of FIG. 4. A single aperture comprises a lens 503, an imager 505, and an aperture processor 507. The lens 503 focuses light from the aperture's visual field 509 onto the imager 505 in a manner forming an image. The lens may be replaced with any optical assembly that forms an image, such as a single lens, a compound lens, or even an open aperture such as a pinhole or a slit. The imager 505 may be a standard CMOS or CCD imager or a vision chip as described above. The imager 505 outputs an image 511, which may be a raw image or a partially processed image, depending on the nature of the imager 505. The aperture processor 507 may be a standard processor such as a microcontroller or digital signal processor chip. The aperture processor 507 may be responsible for operating the imager 505 so that the imager 505 outputs an image 511. The aperture processor 507 may then grab the image 511, optionally process it, and then send an aperture processor output 513 to the data bus 407. Such processing may include simple functions such as windowing, intensity, or color processing, or may include more complex functions such as feature extraction and optical flow measurement. The aperture 501 may also be configured to change it's mode of operation based on commands from the master processor 405. This may include a broadcast mode where the same command is sent to all aperture processors. This may also include the ability to send a specific command to a single aperture processor or set of aperture processors. Alternatively the aperture processor 507 may just control the manner in which the imager 505 outputs the image 511 onto the data bus 407. Alternatively the aperture processor 507 may be a “bridge chip” whose purpose is to interface the imager 505 with a bus protocol such as USB or another serial or parallel protocol.

Each individual aperture has a field of view 509, that depends on the nature and geometry of the imager 505, the lens (or optical assembly) 503, and their relation to each other. Sample factors that may affect field of view include the size of the imager 505, the effective focal length of the lens 503, and the distance between the lens 503 and the imager 505. The array of apertures 403 may then be arranged so that the individual fields of view of the individual apertures point in different directions. The fields of view may be set up to be slightly overlapping so that the entire array collectively covers a larger field of view 409.

The master processor 405 receives the aperture output 513 from each aperture and performs additional processing on the data obtained to generate an output 411. One processing step may be to combine the individual aperture outputs and generate a stitched image, which then forms the master processor's output 411. This output 411 is then sent to whatever system is using the multiple aperture optical system 401.

The architecture 401 of a multiple aperture optical system may be described as an “array of arrays” structure, where imaging is performed by an array of imagers, with each imager comprising an array of photoreceptor or pixel circuits.

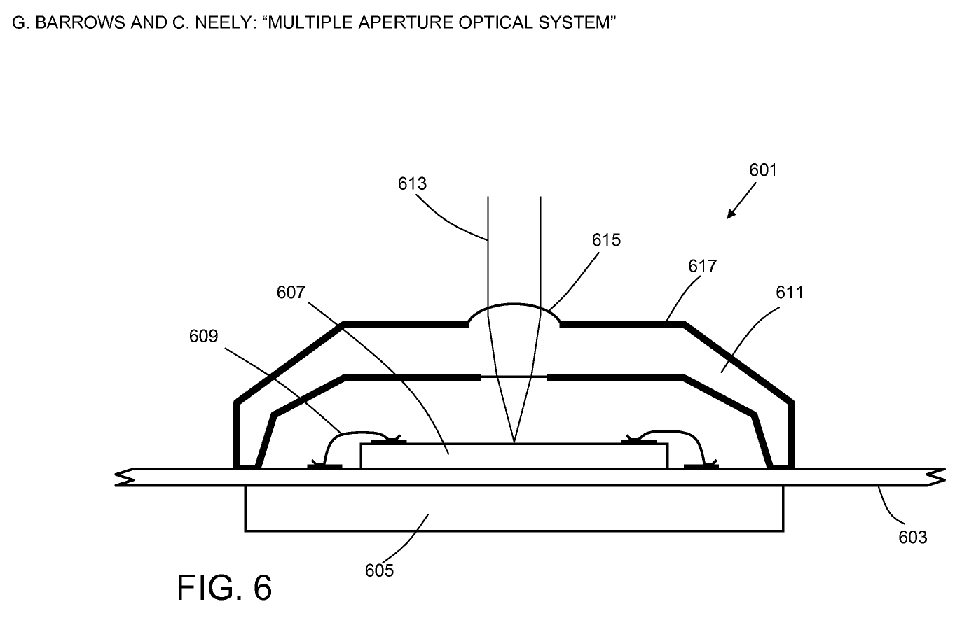

Refer to FIG. 6, which shows one possible exemplary cross section 601 of an individual aperture 501. The aperture components are mounted on a flexible circuit strip 603, which is essentially a printed circuit board whose wiring is printed on a piece of flexible substrate. An aperture processor 605 is mounted on the bottom of the flexible circuit strip 603. The imager 607 is mounted on the top side of the flexible circuit strip 603. The imager 607 is electrically connected to the flexible circuit strip in a manner that enables signals to travel between the imager 607 and the flexible circuit strip 603. This may be achieved with the use of bonding wires, for example bonding wire 609. The flexible circuit strip 603 includes wiring to electrically connect the imager 607 with the aperture processor 605 and any additional components that may be required for operation. Such additional components may include power supply capacitors, bias resistors, oscillators, or other components. The wiring on the flexible circuit strip 603 may include printed wires, vias, or any other type of electrical conductor link. The printing or embedding of such wiring on a flexible circuit strip is a well-known and mature art. The imager 607 is covered with an optical assembly 611, whose purpose is to provide any needed protection to the imager 607 and to focus light 613 from the visual field onto the imager 607 to form an image. Therefore the imager 607 may be defined as being located in between the optical assembly 611 and the flexible circuit strip 603.

To achieve a compact and inexpensive imager, the optical assembly 611 may be fabricated from a single piece of transparent material in a manner that a lens bump 615 is formed at the appropriate height above the imager 607. A lens bump 615 may be any physical protrusion or other shape formed in the optical assembly 611 that enables an image to be focused on the imager 607. Such an optical assembly may be fabricated from press-molded or injection-molded plastic or another transparent material. The optical assembly 611 may also be coated with an opaque coating 617 around all surface areas except for the region near the lens bump 615 on both sides, which is left clear to allow the light 613 to pass through. Such a coating 617 would substantially limit the light striking the imager 607 to only light entering through the lens bump 615, which may enhance the contrast of the grabbed image.

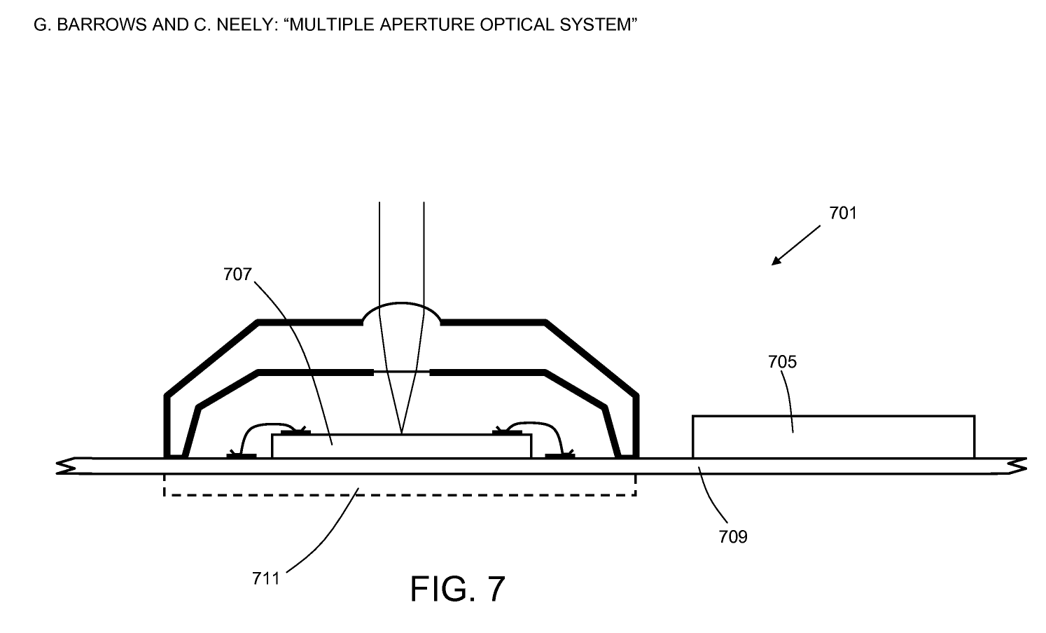

An aperture 501 may be constructed in different ways. For example, FIG. 7 shows a variation 701 of the cross section 601 of FIG. 6 in which a processor 705 is mounted next to an imager 707 on the same side of a flexible circuit strip 709. Depending on the application, it may be appropriate to reinforce the flexible circuit strip 709 in the area underneath the imager 707. This can be performed using an optional reinforcing structure 711 or by using rigid-flex techniques to stiffen the flexible circuit strip underneath the imager 707.

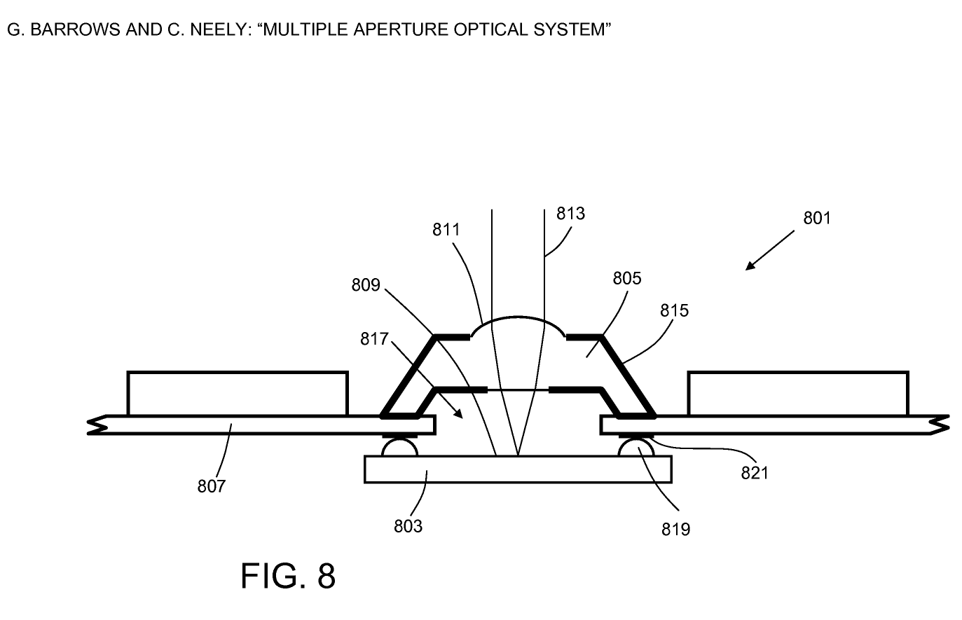

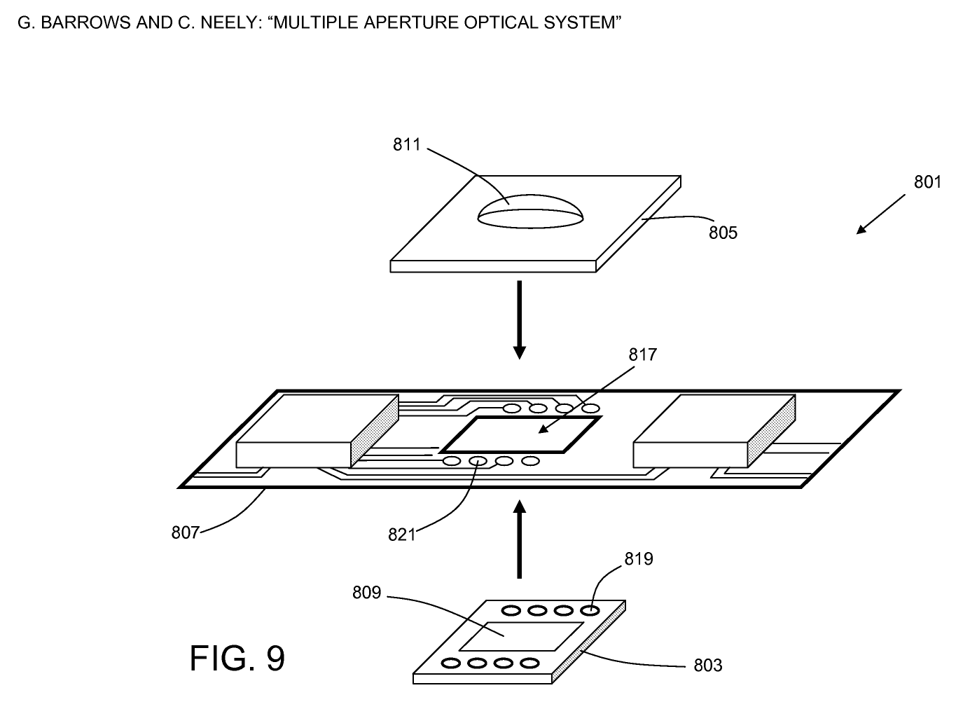

Refer to FIG. 8, which shows another possible cross section 801 of the aperture 501. FIG. 9 shows an exploded view of an aperture constructed according to FIG. 8. In this case, an imager 803 and an optical assembly 805 are located on opposite sides of the flexible circuit strip 807. The imager 803 is mounted face-down onto a flexible circuit strip 807, so that its light sensitive side 809 faces the optical assembly 805. As in the apertures of FIGS. 6 and 7, the optical assembly 805 may be constructed from a single piece of transparent material having a lens bump 811 for focusing light 813 onto the imager 803 and an opaque coating 815 to substantially prevent light from entering except through the lens bump 811. The flexible circuit strip 807 needs to be sufficiently transparent in the region between the optical assembly 805 and the imager 803 to allow light 813 to strike the light sensing side 809 of the imager 803. This may be achieved by using a hole 817 as shown in FIG. 8, or by fabricating the flexible circuit strip 807 with transparent material in the appropriate region. An aperture processor 823 may then be mounted next to the imager 803 and optical assembly 805 on the flexible circuit strip 807.

Any optical assembly constructed substantially from a single piece of material is herein referred to as a “single-piece optical assembly”, including if the single piece of material additionally has an opaque coating and/or an opaque covering. Such a single piece optical assembly has both image forming optics, via a lens bump or similar structure, and a support structure or an enclosing structure formed from the same piece of material. The optical assemblies of FIGS. 6 through 9 are all single-piece optical assemblies.

The vision chip 813 may be electrically connected to the flexible circuit strip 807 using flip-chip bumps 819, equivalently referred to herein as “bumped pads”, that are built on the pads of the imager 803. Such flip chip bumps 819 may connect with mounting pads 821 on the flexible circuit strip 807. The construction and usage of bumped pads for flip-chip mounting techniques is an established art in the semiconductor industry. Optional adhesive (not shown) may be added to physically secure the imager 803 to the flexible circuit strip 807.

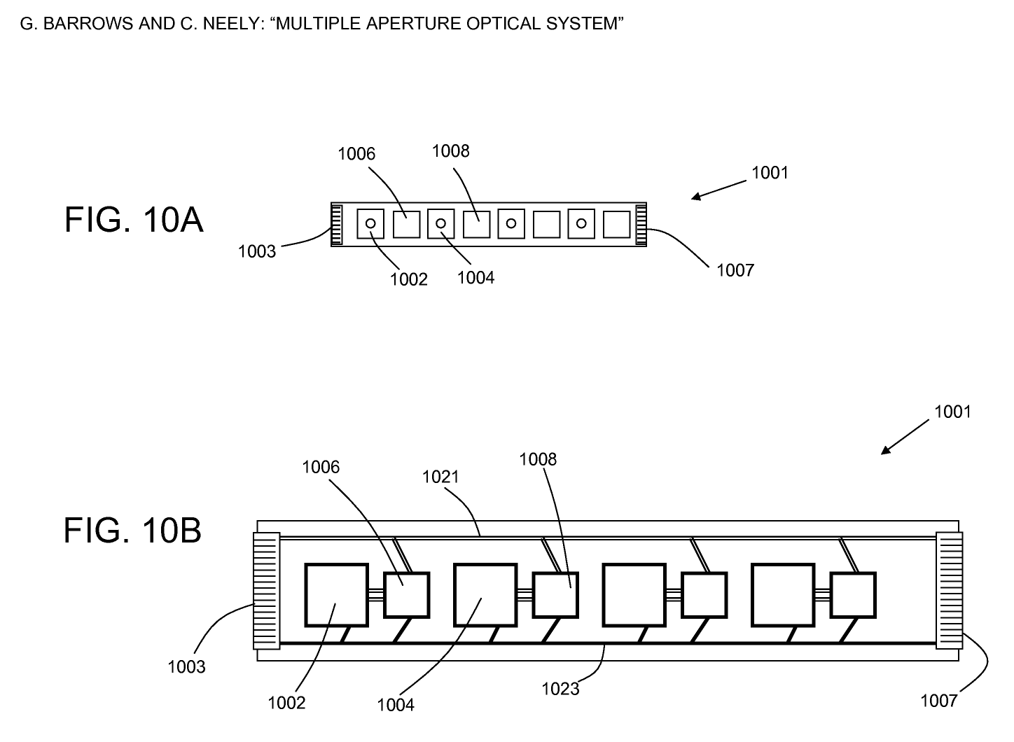

An array of apertures as described above may be mounted together to form a single structure that is referred to herein as an “eye strip”. Refer to FIGS. 10A and 10B, which depicts one possible eye strip 1001. The eye strip shown in contains four apertures, comprising four imagers (e.g. imager 1002, imager 1004, etc.) and four aperture processors (e.g. aperture processor 1006, aperture processor 1008, etc.), but any number of apertures may be included on the eye strip. The eye strip of FIG. 10A is shown having apertures of the type in FIG. 7, however eye strips may have apertures implemented in any manner, including but not limited to the structures of FIGS. 6 and 8. Terminal ports 1003 and 1007 may be used to allow the eye strip to be connected with other eye strips or other devices. An eye strip may have any number of terminal ports depending on the specific implementation and application needs.

FIG. 10B shows the electrical connectivity of the eye strip 1001. Imagers are connected to their aperture processors. A data bus 1021 provides a communication link to the aperture processors and optionally from one aperture processor to another. The data bus 1021 may be any standard communications interface such as USB, I2C, SPI, CANbus, any combination thereof, or any other appropriate standard or custom designed protocol. Depending on the bandwidth needs of an application, data bus 1021 may be common to all aperture processors, as shown in FIG. 10B, or separate busses may be sent to individual aperture processors or groups of processors. The eye strip also includes a power bus 1023 which provides power to the electronics on the eye strip. The power bus includes all power signals necessary to drive the electronics, which may include one or more ground signals and one or more power signals, and may include separate analog and digital power signals. In order to provide an interface between the eye strip and other electronics, a terminal port 1003 may be added to the eye strip. The terminal port 1003 may provide connections for power signals, the data bus, and/or any other needed signals. The terminal port 1003 may involve a mechanical coupling such as a JST connector, or may be a simple pad or hole enabling electrical connection using other connecting methods. Depending on the application and specific eye strip shape, additional termination ports, for example terminal port 1007, may be added at the opposite end or elsewhere on the eye strip.

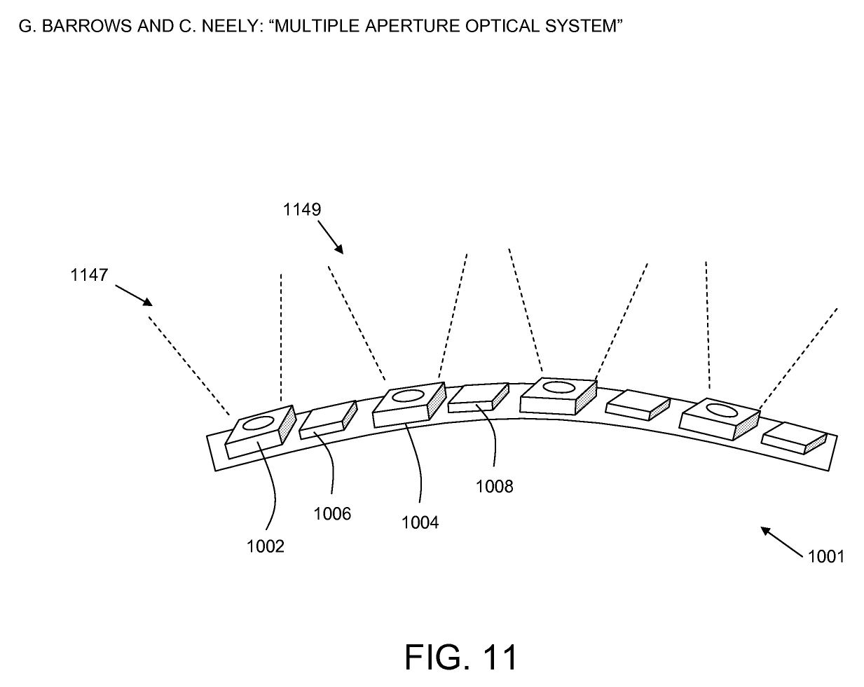

Refer to FIG. 11, which shows another view of the eye strip 1001 of FIGS. 10A and 10B in which the eye strip 1001 is bent. Each aperture has its own field of view, for example field of view 1147 and 1149 respectively for imagers 1006 and 1008. The primary advantage of the eye strip construction is that the flexible circuit strip 1149 can be bent. This allows each aperture to look in a separate direction. With a properly chosen bend, the eye strip can be configured to image a wider field than that covered by an individual aperture. Depending on the needs of the specific application, the apertures may be positioned so that their fields of view may or may not overlap.

For purposes of discussion, an eye strip bent so that its apertures are pointing different directions, whether overlapping or not, will be referred to herein as an eye strip with apertures have diverging fields of view. Eye strips configured so that even only one aperture is pointing a different direction will be considered to have apertures with diverging fields of view. Likewise any collection of apertures arranged so that they are pointing in different directions, even if only one aperture is pointing in a different direction, will be considered to be apertures having diverging fields of view.

Although FIGS. 10A, 10B, and 11 show eye strips as having a single row of apertures arranged on a single long strip, other arrangements are possible. Eye strips may have multiple rows of apertures, and may be made to form other shapes beyond simple long straight strips.

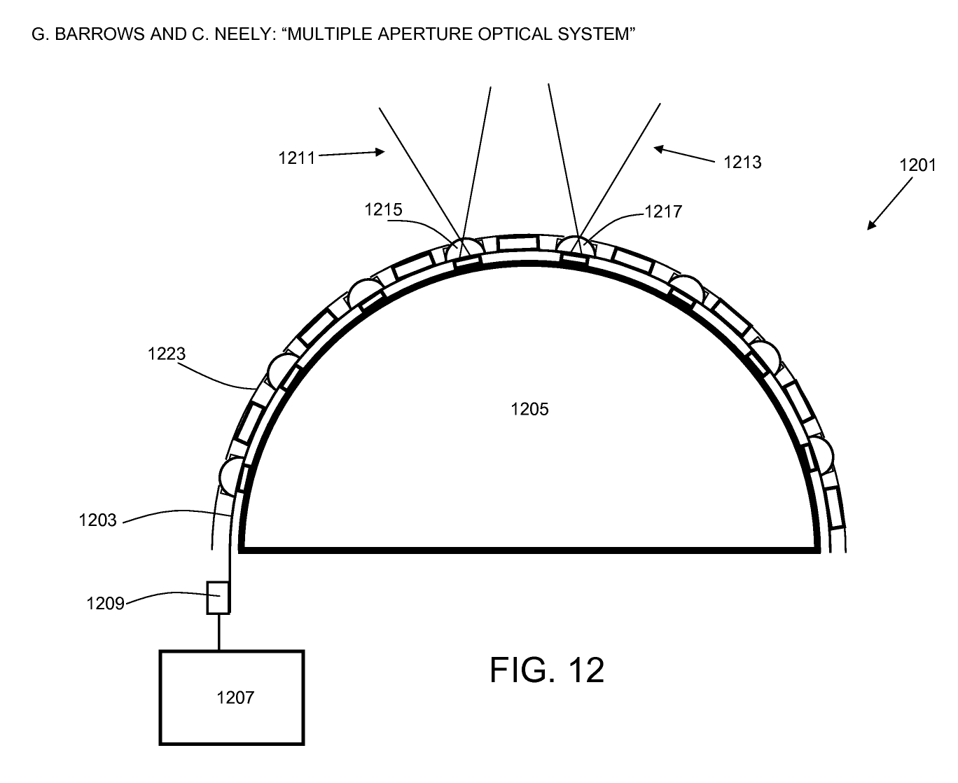

FIG. 12 depicts an exemplary embodiment 1201 of the present teaching. An eye strip 1203 of the type described above is wrapped around an underlying structure 1205 and therefore its apertures have diverging fields of view. In this manner, the eye strip 1203 physically conforms to the shape of the underlying structure 1205. An optional termination port 1209 on the eye strip may serve as the connection between the eye strip 1203 and the master processor 1207. The bent shape of eye strip 1203 causes the fields of view of individual apertures to point in different directions. For example, the fields of view 1211 and 1213, which respectively correspond to imagers 1215 and 1217, point in different directions. To facilitate camera calibration and image stitching, the apertures of the eye strip 1203 may be set up so that the fields of view of adjacent apertures overlap slightly. In this manner, the eye strip 1203 can continuously cover a much wider field of view than that possible by a single aperture. The eye strip 1203 may also be covered with an optional thin protective cover 1223 that protects the eye strip 1203 and its components from the environment. The protective cover 1223 may be open or optically transparent over the lens bumps of each optical assembly or otherwise configured to allow light through to the apertures.

Note that although FIG. 12 shows the eye strip 1203 wrapped around a round object 1205, the eye strip 1203 may be wrapped around objects of other shapes, including but not limited to the chassis of a mobile robot or body of an air frame. The eye strip 1203 may be mounted on any appropriate support structure. Likewise the eye strip 1203 may be wrapped around on the inside of a support structure, with holes or optical transparent sections positioned to allow the apertures to view outside the support structure. For some applications, the eye strip 1203 may even be wrapped around the inside of an object and positioned to image the inside, which will provide a view of the object's interior from various angles.

As described above, the master processor 1207 includes a program to communicate with the individual aperture processors. This may include sending any required commands or synchronization signals, as well as reading the output from each aperture. The master processor may also include algorithms to perform appropriate processing on the aperture processor outputs. Sample algorithms may include camera calibration and image stitching. Generally speaking, camera calibration is the method by which the specific fields of view of each aperture are measured with respect to each other. Stitching is the method that combines the individual aperture outputs to form a stitched image. The stitched image may be an image that would have been obtained by a hypothetical single aperture camera having fisheye optics. In some embodiments, calibration algorithms may be executed prior to the use of stitching algorithms. In other embodiments, calibration and stitching algorithms may be concurrently implemented.

The purpose of any camera calibration algorithm is to obtain the calibration parameters of every imager in a multiple aperture optical system. Calibration parameters may include any or all of the following: 1) Pitch and yaw angular positions that indicate the direction in the visual field to which each imager's field of view points. 2) A roll angular measurement that indicates how each image is rotated in place. 3) “X”, “Y”, and “Z” measurements that indicate the position of each imager in three-dimensional space. 4) Focal length and lateral displacement measurements that indicate the position of the imager relative to its lens or (or other optical aperture). 5) Any other calibration measurements accounting for image distortion caused by the lens (or other optical aperture) including but not limited to pincushion distortion and barrel distortion. Roll, pitch, and yaw angular measurements and “X”, “Y”, and “Z” measurements may be made with respect to an objective coordinate system or relative to a selected aperture. Camera calibration may be performed using a calibration pattern or using natural texture in the vicinity of the multiple aperture optical system, depending on the specific calibration algorithm used. Camera calibration is an established art that is well documented in the open literature. Examples of camera calibration techniques that may be considered include the following papers listed in the reference section: the 1987 journal paper by Tsai, the 1997 conference paper by Heikkila and Silven, the 1998 journal paper by Clarke and Fryer, the 1999 conference paper by Sturm and Maybank, and the 1999 conference paper by Zhang. Other techniques are discussed in the book Image Alignment and Stitching by R. Szeliski. These references are provided as examples and do not limit the scope of calibration algorithms that may be applicable.

The purpose of any image stitching algorithm is to combine the aperture outputs from each aperture into a single stitched image (or equivalently a composite image) or a set of stitched images. In this manner, a wide field of view image or an omnidirectional image of the visual field may be constructed by the master processor. If camera calibration parameters have been obtained, image stitching may be performed using the following steps: First, set up a working array whose dimensions are the size of the stitched image that will be generated. Each element of the working array may include a sum value, a count value, and a result value. Set the count values of each working array element to zero. Second, for each aperture output, map its image into the working array. To perform this step, for each pixel of the aperture output perform the following: Use the camera calibration patterns to find the working array element onto which the pixel of the aperture output maps. Then add the value of that pixel to the sum value of the working array element. Then increment the count value of the working array element. Third, for each working array element whose count value is one or more, set the result value of the working array element equal to the sum value divided by the count value. Fourth, for all working array elements whose count values are equal to zero, use interpolation (or other) techniques to compute a result value from one or more of the closest working array elements having a computed result value. The result values for all the working array elements form the stitched image. This four-step process is provided as an example and does not limit the scope of stitching algorithms that may be applicable. The resulting stitched image may be outputted by the master processor 1207 as a master processor output.

Image stitching is an established art that is well documented in the open literature. Other examples of image stitching techniques that may be considered are discussed in the book Image Alignment and Stitching by R. Szeliski. This reference is provided as examples and do not limit the scope of image stitching algorithms that may be applicable.

Note that the master processor 1207 may generate a variety of data to be provided as a master processor output. The master processor output may also be of the form of an array of optical flow measurements or higher level information based on the multiple aperture optical system's visual field including, but not limited to, information on the presence or absence of targets of interest.

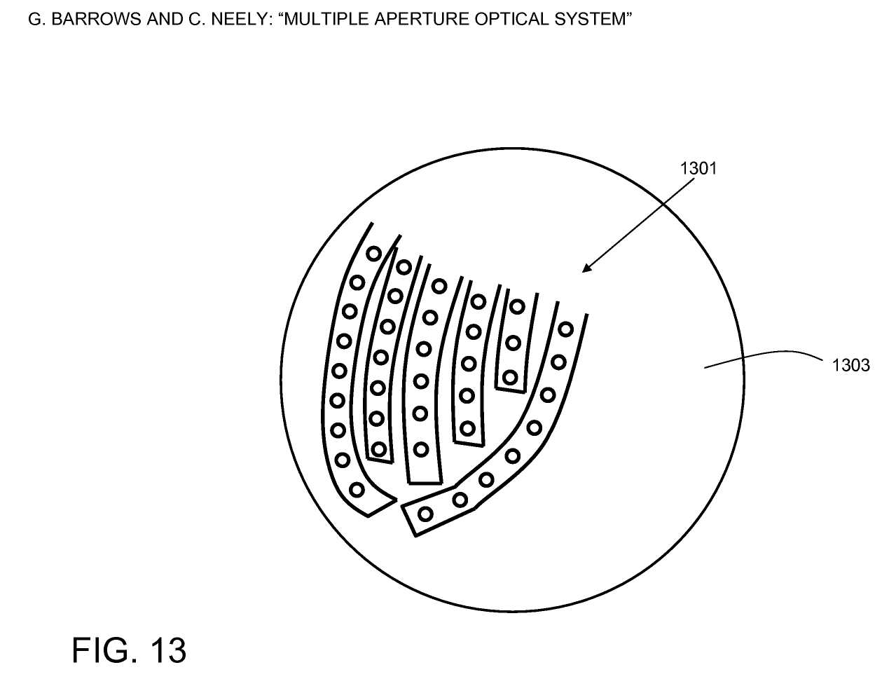

Multiple eye strips may be mounted side by side to achieve yet a wider field of view. This is shown in FIG. 13, where several eye strips 1301 are mounted next to each other on top of a spherical support structure 1303. The apertures on these eye strips 1301 thus have diverging fields of view. The optical assemblies of each eye strip in this figure are denoted by a small circle. Each eye strip may then have its own master processor, or all the eye strips may share the same master processor. Using this method, a wide field of view or even a full omnidirectional image of the environment can be achieved and presented as a master processor output. The usage of aperture processors allows parallel processing of the grabbed imagery to occur over the entire field of view.

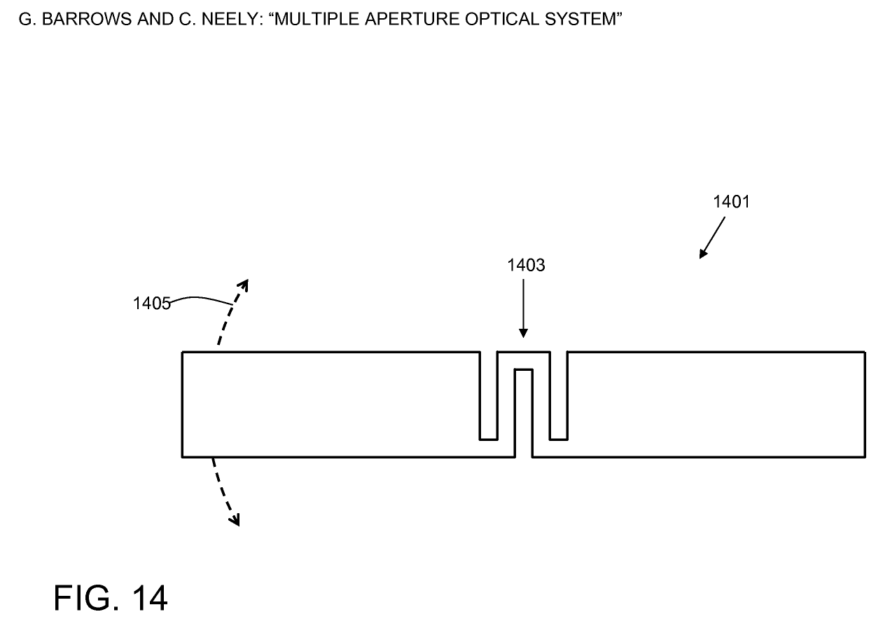

The eye strip structure as introduced above is primarily flexible in one direction. For some applications it may be appropriate for the eye strip to be flexible sideways, in particular to help cover a three-dimensional round shape such as the spherical structure 1303 in FIG. 13. FIG. 14 shows a flexible circuit strip 1401 having a serpentine structure 1403 that allows some flexibility in the sideways directions 1405. In order to increase flexibility, the serpentine structure 1403 may be designed to contain only data bus and power bus lines in order to minimize its width.

The above teachings may be used to implement a multiple aperture optical system that addresses the challenges outlined above in the background section. Appropriate positioning of eye strips enables a wide field of view to be monitored at the same time, up to and including a full spherical field of view. The eye strip architecture may be manufactured in a thin manner that wraps around an underlying structure, thus adding minimal volume. When utilizing aperture processors, the system is parallel, with a separate processor for each section of the visual field to enhance overall system speed and enable operation at higher frame rates than that possible without parallel processing. The smaller form factor plus the use of multiple apertures may also increase the physical robustness of the entire system because the system may be configured so that if one aperture is damaged, the remainder of the array still functions. Furthermore the smaller volume may allow construction techniques able to withstand shock or large accelerations.

A number of modifications to the above exemplary embodiment are possible. Below is a list of modifications that may be applied. These modifications can be applied separately or in many cases in combination.

### Alternative Embodiment 1

As described above in the prior art section, there exist techniques for fabricating optical flow sensors that are fast and compact. Such optical flow sensors utilize a “vision chip”, which is an integrated circuit having both image acquisition and low-level image processing on the same die. The output of a vision chip may comprise a processed image rather than a raw image obtained from photoreceptor or pixel circuits. The output of a vision chip is referred to herein as a vision chip output, and may comprise pixel values, contrast-enhanced pixel values, or the output of feature detectors such as edge detectors. The outputs of any feature detectors on the vision chip are referred to herein as feature signals. A variation of the above exemplary embodiments is to utilize vision chips for some or all of the imagers. Then the vision chip output would form the image output (e.g. output 511) of each aperture. An advantage of this variation is that the processing implemented by the vision chip would be parallelized throughout the entire multiple aperture optical system, thus reducing the demand on the master processor. A variety of vision chips may be utilized, including all of the vision chip designs listed in the above prior art section, including above-referenced cellular neural network (CNN) chips. A vision chip may also be configured to have a full processor on the same die as the imaging circuits. In this case, both the vision chip and the aperture processor may reside on the same piece of silicon.

Each vision chip will have a field of view that depends on the size of the light-sensitive part of the vision chip and the position and nature of the optical assembly relative to the vision chip. This field of view is referred to herein as the “vision chip field of view”. The region of the environment that can be seen by a vision chip is referred to herein as the “vision chip vision field”.

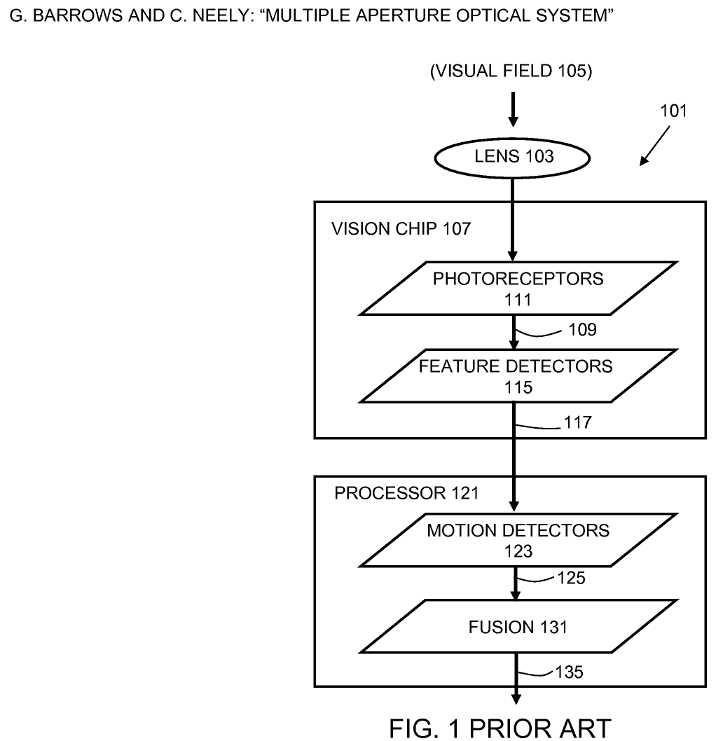

A further variation is to utilize a vision chip configured to support optical flow processing, such as the vision chip 107 of the prior art optical flow sensor 101 of FIG. 1. The output of this vision chip 107 comprises an array of binary feature signals 117, which herein may also be referred to as feature signals. The aperture processor 507 of each aperture 501 may then comprise the same or similar optical flow sensing algorithms as the processor 121 of the prior art optical flow sensor 101. The resulting optical flow measurements generated by the aperture processor 507 may then be sent to the master processor 405 via the data bus 407. In this case, each aperture comprises an optical flow sensor. Alternatively the aperture processor may perform additional computations on the optical flow measurements before generating an output. The area of the visual field or environment from which an individual optical flow sensor generates optical flow measurements is herein referred to as the optical flow sensor's “optical flow sensor visual field”.

If the master processor 405 is performing image stitching functions on the optical flow information generated by apertures, the information being sent to the master processor 405 may be optical flow information. Individual optical flow vectors from different portions of the visual field may then be stitched to form a composite optical flow field using several steps. First, for each aperture, create an “image” from the optical flow vectors output by the aperture. Each “pixel” of the image may be a vector value to represent both X- and Y-components of optical flow. Second, rotate the optical flow vectors in a manner that accounts for the rotation calibrations of each aperture. Third, stitch together the optical flow field using image stitching techniques. The resulting stitched image may then be outputted as a master processor output 411.

### Alternative Embodiment 2

In the above teachings, each aperture comprises an aperture processor, an imager, and an optical assembly. For some applications, the CPU speed and memory demands on the aperture processors may be adequately relaxed that several imagers (or vision chips) may share the same aperture processor. Such a modification may be lighter, less power consumptive, and require fewer components than a multiple aperture optical system in which every imager (or vision chip) has a dedicated processor.

### Alternative Embodiment 3

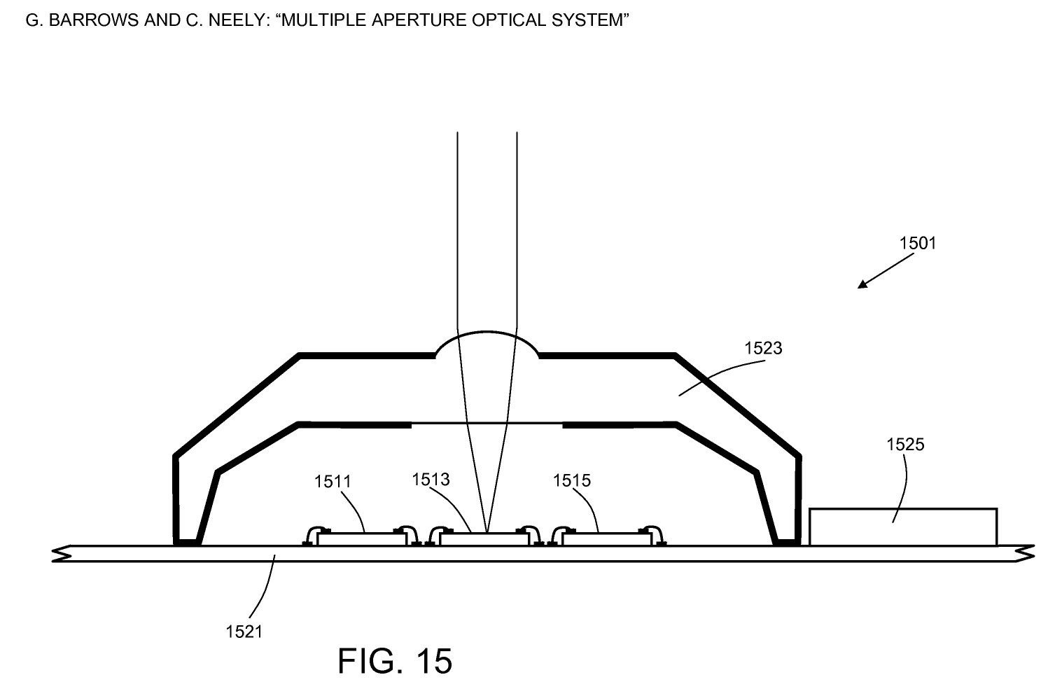

In the above teachings, every aperture comprises one imager or vision chip. Another variation is for several imagers or vision chips to share the same optical assembly. Such an aperture may be referred to as a multiple imager aperture. FIG. 15 depicts such a multiple imager aperture 1501. In this variation, multiple imagers 1511, 1513, and 1515 may be mounted next to each other on a flexible circuit strip 1521. The imagers 1511, 1513, and 1515 may all mounted beneath the same optical enclosure 1523. Depending on the processing needs, one aperture processor 1525 may be enough to handle the processing, or multiple aperture processors may be practical.

In this variation, each imager would image a separate part of the visual field. The field of view of this aperture will have gaps corresponding to the spaces between the imagers. This characteristic reduces the scope of applications for which this variation may be applied.

### Alternative Embodiment 4

The above exemplary embodiment utilizes a single master processor that communicates with all of the aperture processors on one or more eye strips. Another variation is to utilize more than one master processor. Each master processor may handle a subset of all the eye strips, or just a single eye strip. Alternatively several master processors may implement a parallel computer for processing the aperture outputs. This variation may be useful if a single master processor does not have adequate speed or memory for a given application.

Depending on the application, there may be additional layers of processing before an output is generated. It is possible to implement a multiple layer architecture, each layer comprising a layer of processors, which together and in a parallel fashion acquire and process the visual information grabbed by the apertures. This variation may be particularly useful when many eye strips or apertures are in use.

### Alternative Embodiment 5

In another variation, aperture processors are not used. Instead, the imagers may be directly connected to the master processor. In this case, each aperture would comprise an optical assembly and an imager, and the imagers would produce the aperture outputs being sent to the master processor. This variation may require that the individual imagers have some sort of “chip select” mechanism which would allow the master processor 405 to connect selected imagers to the data bus 407. This method is appropriate for applications in which the master processor has adequate throughput and memory for the given application.

### Alternative Embodiment 6

Another variation is to use an open aperture such as a pinhole or a slit in place of the lens bump. The lens may be replaced with any optical mechanism that enables an image of a desired quality to be focused onto the imager.

### Alternative Embodiment 7

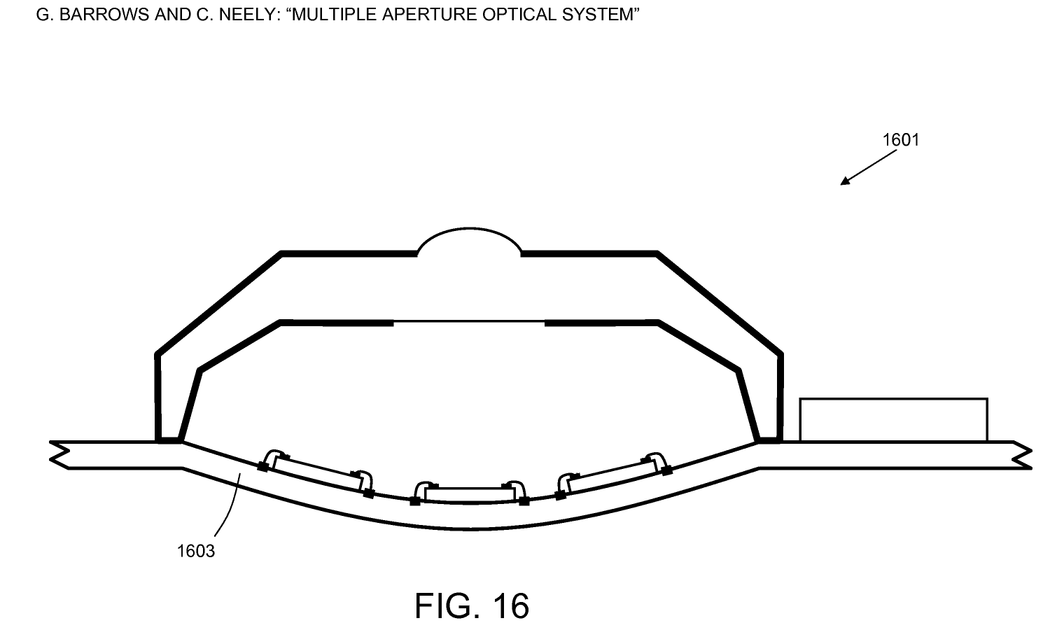

Refer to FIG. 16, which shows a curved multiple imager aperture 1601. This aperture 1601 is a variation of the embodiment of FIG. 15. The flexible circuit strip 1603 is bent as shown, and may be used to widen the field of view of a given aperture.

### Alternative Embodiment 8

It is possible to implement a multiple aperture optical system in which there is more than one type of aperture. For example, some of the apertures may utilize imagers optimized for resolution but not speed. Other apertures may then utilize vision chips and appropriate aperture processor algorithms optimized for speed and running optical flow algorithms, but not optimized for resolution. Then both optical flow information and high resolution image information may be sent to the master processor. Additionally, each aperture may be outfitted with an additional color filter, so that only light within a predefined bandwidth may strike the imager. If different apertures have their own bandwidth, and if the apertures have sufficient overlap, then a hyperspectral multiple aperture optical system may be fabricated.

### Alternative Embodiment 9

A variation of the above embodiment is to fabricate the flexible circuit strip with a material whose flexibility is conditional. For example, the flexible circuit strip material may be rigid under normal temperatures, but then may become flexible when heated, at which point it can be bent to a new shape. After being bent, the flexible circuit strip may be cooled or otherwise treated to become firm again. In fact, the flexible circuit strip need not be flexible at all once it has been formed to a desired shape. The flexible circuit strip may also be made of a material that is normally rigid but will bend with adequate force. Any eye strip whose circuit strip is flexible, can be made flexible under certain conditions, or can be bent with application of adequate force, is defined to be an eye strip with a flexible nature.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

### U.S. Patent Documents Cited

| | | | |
|---|---|---|---|
| 6,020,953 | February 2000 | Barrows | 356/28 |
| 6,194,695 | February 2001 | Barrows | 250/208.1 |
| 6,384,905 | May 2002 | Barrows | 356/28 |
| 6,493,068 | December 2002 | Barrows | 356/28 |
| 6,683,678 | January 2004 | Barrows | 356/28 |

### OTHER PUBLICATIONS CITED

J. Gibson, The Ecological Approach to Visual Perception, Houghton Mifflin, Boston, 1950.
R. Tsai, “A versatile camera calibration technique for high accuracy 3D machine vision metrology using off-the-shelf TV cameras and lenses”, IEEE J. Robotics and Automation, pp. 323-344, Vol. 3(4), 1987.
C. Mead, Analog VLSI and Neural Systems, ISBN 0201059924, Addison Wesley, 1989.
J. Heikkila and O. Silven, “A four-step camera calibration procedure with implicit image correction”, Proceedings of the IEEE Conference on Computer Vision and Pattern Recognition, pp 1106-1112, 1997.
T. Clarke and J. Fryer, “The development of camera calibration methods and models”, Photogrammetric Record, 16(91), pp. 51-66, April 1998.
A. Moini, Vision Chips, ISBN 0792386647, Kluwer Academic Publishing, Norwell, Mass., 1999.
K. Miller and G. Barrows, “Feature tracking linear optic flow sensor chip”, 1999 International Symposium on Circuits and Systems (ISCAS'99), Orlando, Fla., IEEE, May 1999.
G. Barrows, K. Miller, and B. Krantz, “Fusing neuromorphic motion detector outputs for robust optical flow measurement,” 1999 International Joint Conference on Neural Networks (IJCNN'99), Washington, D.C., IEEE, July 1999.
G. Barrows, Mixed-Mode VLSI Optical Flow Sensors for Micro Air Vehicles, Ph.D. Dissertation, Department of Electrical Engineering, University of Maryland at College Park, College Park, Md., December 1999.
P. Sturm and S. Maybank, “On plane-based camera calibration: a general algorithm, singularities, applications”, IEEE Conference on Computer Vision and Pattern Recognition, pp. 432-437, 1999.
Z. Zhang, “Flexible camera calibration by viewing a plane from unknown orientations”, International Conference on Computer Vision (ICCV'99), Corfu, Greece, pages 666-673, September 1999.
G. Barrows and C. Neely, “Mixed-mode VLSI optical flow sensors for in-flight control of a micro air vehicle”, SPIE Vol 4109: Critical Technologies for the Future of Computing, July 2000.
G. Barrows, C. Neely, and K. Miller, “Optical flow sensors for MAV navigation”, Chapter 26, in Fixed and Flapping Wing Aerodynamics for Micro Air Vehicle Applications, Volume 195, Progress in Astronautics and Aeronautics, AIAA, 2001.

T. Roska and A. Rodríguez-Vázquez, eds., Towards the Visual Microprocessor, VLSI Design and the Use of Cellular Neural Network Universal Machines, Wiley, ISBN 0471956066, 2001.
G. Barrows, J. Chahl, and M. Srinivasan, “Biologically inspired visual sensing and flight control”, The Aeronautical Journal of the Royal Aeronautical Society, 107(1069), March 2003.
R. Szeliski, Image Alignment and Stitching, ISBN 978-1-933019-04-8, 2006.

1. A multiple aperture optical system comprising:
at least one eye strip, wherein each said eye strip comprises a plurality of apertures and each said aperture is configured to generate an aperture output from the visual field of said aperture; and
a master processor configured to receive said aperture outputs from said at least one eye strip and produce a master processor output from said aperture outputs.

2. The multiple aperture optical system of claim 1, wherein:
said apertures are configured to have diverging fields of view; and
each said eye strip is flexible.

3. The multiple aperture optical system of claim 2, wherein at least one of said apertures comprises:
a vision chip; and
an optical assembly configured to form an image from the vision chip visual field of said vision chip, wherein said vision chip is configured to generate a vision chip output from said vision chip visual field.

4. The multiple aperture optical system of claim 3, wherein at least one of said vision chips is further configured to generate a plurality of feature signals from said vision chip visual field.

5. The multiple aperture optical system of claim 4, wherein said multiple aperture optical system is mounted on a mobile robotic system.

6. The multiple aperture optical system of claim 2, wherein at least one of said apertures comprises an optical flow sensor configured for generating at least one optical flow measurement.

7. The multiple aperture optical system of claim 6, wherein at least one of said optical flow sensors comprises:
a vision chip configured for generating a plurality of feature signals from the vision chip visual field of said vision chip; and
an aperture processor configured for generating at least one optical flow measurement from said plurality of feature signals.

8. The multiple aperture optical system of claim 7, wherein said multiple aperture optical system is mounted on a mobile robotic system.

9. The multiple aperture optical system of claim 2, wherein said master processor is configured to generate a stitched image from said aperture outputs.

10. The multiple aperture optical system of claim 6, wherein said multiple aperture optical system is further configured to be mounted on a mobile robotic system.

11. The multiple aperture optical system of claim 9, wherein at least one of said apertures comprises an optical flow sensor configured for generating at least one optical flow measurement from the visual field of said optical flow sensor.

12. The multiple aperture optical system of claim 11, wherein said optical flow sensor comprises:
a vision chip configured for generating a plurality of feature signals from the vision chip visual field of said vision chip; and
an aperture processor configured for generating at least one optical flow measurement from said plurality of feature signals.

13. The multiple aperture optical system of claim 1, wherein:
said eye strips comprise a flexible circuit strip; and
at least one of said apertures comprises a single piece optical assembly and an imager, and said imager is configured to generate a plurality of pixel values based on the visual field of said imager.

14. The multiple aperture optical system of claim 13, wherein at least one of said imagers is mounted between one said single piece optical assembly and said flexible circuit strip.

15. The multiple aperture optical system of claim 14, wherein at least one of said single piece optical assemblies comprises a lens bump.

16. The multiple aperture optical system of claim 14, wherein said apertures are configured to have diverging fields of view.

17. The multiple aperture optical system of claim 13, wherein:
at least one of said imagers is mounted on one side of a said flexible circuit strip;
one said single piece optical assembly is mounted on the other side of said flexible strip; and
said flexible strip is configured to be optically transparent in between said imager and said single piece optical assembly.

18. The multiple aperture optical system of claim 17, wherein said imager is electrically connected to said flexible circuit strip using bumped pads.

19. The multiple aperture optical system of claim 18, wherein at least one of said single piece optical assemblies comprises a lens bump.

20. The multiple aperture optical system of claim 17, wherein at least one of said single piece optical assemblies comprises a lens bump.

21. The multiple aperture optical system of claim 17, wherein said apertures are configured to have diverging fields of view.
